(19) United States
(12) Patent Application Publication
(10) Pub. No.: US 2022/0068265 A1
(43) Pub. Date: Mar. 3, 2022

(54) METHOD FOR DISPLAYING STREAMING SPEECH RECOGNITION RESULT, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Junyao SHAO, Beijing (CN); Sheng QIAN, Beijing (CN)

(21) Appl. No.: 17/521,473

(22) Filed: Nov. 8, 2021

(30) Foreign Application Priority Data
Nov. 18, 2020 (CN) 202011295751.2

(51) Int. Cl. G10L 15/16; G10L 15/04; G10L 15/02; G10L 15/22

(52) U.S. Cl. CPC G10L 15/16; G10L 15/04; G06N 3/08; G10L 15/22; G10L 2015/221; G10L 15/02

(57) ABSTRACT

The disclosure discloses a method for displaying a streaming speech recognition result, relates to a field of speech technologies, deep learning technologies and natural language processing technologies. The method includes: obtaining a plurality of continuous speech segments of an input audio stream, and simulating an end of a target speech segment in the plurality of continuous speech segments as a sentence ending, performing feature extraction on a current speech segment to be recognized based on a first feature extraction mode when the current speech segment is the target speech segment; performing feature extraction on the current speech segment based on a second feature extraction mode when the current speech segment is not the target speech segment; and obtaining a real-time recognition result by inputting a feature sequence extracted from the current speech segment into a streaming multi-layer truncated attention model, and displaying the real-time recognition result.

### CROSS-REFERENCE TO RELATED APPLICATION

The disclosure claims priority to Chinese Patent Application No. 202011295751.2, filed on Nov. 18, 2020, the content of which is hereby incorporated by reference into this disclosure.

### FIELD

The disclosure relates to a field of computer technologies and more particularly to fields of speech technologies, deep learning technologies and natural language processing technologies, and further relates to a method for displaying a streaming speech recognition result, an electronic device, and a storage medium.

### BACKGROUND

Speech recognition refers to a process of converting a speech signal into a corresponding text through a computer, which is one of main ways for realizing interaction between humans and machines. Real-time speech recognition refers to performing recognition on each segment of a received continuous speech to obtain a recognition result in real time, so that there is no need to wait for the whole speech input to start the recognition process. In online continuous speech recognition with a large vocabulary, a recognition accuracy and a response speed of the system are key factors affecting system performance. For example, in a scene where a user expects to see the recognition result displayed in real time while speaking, it is necessary for a speech recognition system to decode the speech signal and to output the recognition result in time and quickly while maintaining a high recognition rate.

### SUMMARY

According to an aspect of the disclosure, a method for displaying a streaming speech recognition result is provided. The method includes: obtaining a plurality of continuous speech segments of an input audio stream, and simulating an end of a target speech segment in the plurality of continuous speech segments as a sentence ending, the sentence ending being configured to indicate an end of input of the audio stream; performing feature extraction on a current speech segment to be recognized based on a first feature extraction mode when the current speech segment is the target speech segment; performing feature extraction on the current speech segment based on a second feature extraction mode when the current speech segment is not the target speech segment; and obtaining a real-time recognition result by inputting a feature sequence extracted from the current speech segment into a streaming multi-layer truncated attention model, and displaying the real-time recognition result.

According to an aspect of the disclosure, an electronic device is provided. The electronic device includes: at least one processor and a memory. The memory is communicatively coupled to the at least one processor. The memory is configured to store instructions executable by the at least one processor. The at least one processor is caused to implement the method for displaying the streaming speech recognition result according to the first aspect of embodiments of the disclosure when the instructions are executed by the at least one processor.

According to an aspect of the disclosure, a non-transitory computer readable storage medium having computer instructions stored thereon is provided. The computer instructions are configured to cause a computer to execute the method for displaying the streaming speech recognition result according to the first aspect of embodiments of the disclosure.

It should be understood that, content described in the Summary is not intended to identify key or important features of embodiments of the disclosure, nor is it intended to limit the scope of the disclosure. Other features of the disclosure will become apparent from the following description.

### BRIEF DESCRIPTION OF THE DRAWINGS

The accompanying drawings are used for better understanding the solution and do not constitute a limitation of the disclosure.

FIG. 1 is a schematic diagram illustrating a streaming speech recognition result in the related art.

FIG. 2 is a block diagram illustrating a processing procedure of speech recognition according to embodiments of the disclosure.

FIG. 3 is a flow chart illustrating a method for displaying a streaming speech recognition result according to an embodiment of the disclosure.

FIG. 4 is a schematic diagram illustrating a display effect of a streaming speech recognition result according to an embodiment of the disclosure.

FIG. 5 is a flow chart illustrating a method for displaying a streaming speech recognition result according to another embodiment of the disclosure.

FIG. 6 is a flow chart illustrating a method for displaying a streaming speech recognition result according to another embodiment of the disclosure.

FIG. 7 is a block diagram illustrating an apparatus for displaying a streaming speech recognition result according to an embodiment of the disclosure.

FIG. 8 is a block diagram illustrating an apparatus for displaying a streaming speech recognition result according to another embodiment of the disclosure.

FIG. 9 is a block diagram illustrating an electronic device for implementing a method for displaying a streaming speech recognition result according to embodiments of the disclosure.

### DETAILED DESCRIPTION

Description will be made below to exemplary embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

In the description of embodiments of the disclosure, the term “include” and its equivalents should be understood as an open “include”, that is. “include but not limited to”. The term “based on” should be understood as “based at least in part (at least partially based on)”. The term “an embodiment” or “the embodiment” should be understood as “at least one embodiment”. The term “some embodiments” should be understood as “at least some embodiments”. Other explicit and implicit definitions may be included below.

A connectionist temporal classification (CTC) model is an end-to-end model, and is used for speech recognition with a large vocabulary, such that an acoustic model structure including a DNN (deep neural network) and an HMM (hidden Markov model) is replaced by a unified neural network structure. In this way, a structure of the acoustic model are greatly simplified, training difficulty of the acoustic model is greatly reduced, and an accuracy of a speech recognition system is further improved. In addition, an output result of the CTC model may include peak information of a speech signal.

An attention model is an extension of an encoder-decoder model, and the attention model may improve a prediction effect on a long sequence. Firstly, an input audio feature is encoded by employing a GRU (gate recurrent unit, which is a recurrent neural network) or a LSTM (long short-term memory network) model to obtain hidden features. Then corresponding weights are assigned to different parts of the hidden features through the attention model. Finally, corresponding results are outputted based on different modeling granularities by the decoder. This joint modeling of the acoustic model and the language model may further simplify the complexity of the speech recognition system.

A streaming multi-layer truncated attention (SMLTA) model is a streaming speech recognition model based on the CTC and the attention model. The term “streaming” represents that increment decoding is directly performed on the small segments instead of a whole sentence of a speech, segment by segment. The term “multi-layer” represents stacking multiple layers of attention models. The term “truncated” represents that the speech is segmented into multiple small segments by utilizing peak information of the CTC model, and that modeling and decoding of the attention model may be performed on the multiple small segments. The SMLTA model transforms conventional global attention modeling into local attention modeling, so such a process may be a process that can be realized by streaming. No matter how long a sentence is, streaming decoding and accurate local attention modeling may be implemented by means of segmentation, thereby implementing streaming decoding.

The Applicant founds that, in order to display all recognition results on the screen as soon as possible when performing streaming speech recognition by the SMLTA model, the streaming display on the screen of the recognition result is implemented by splicing an output result of the CTC module and an output result of an attention decoder in the SMLTA model in the related art. However, the output result of the CTC module is different from the output result of the attention decoder in the SMLTA model due to a characteristic of the SMLTA model, which may cause a problem that connection points cannot be accurately found when the two output results are spliced, and causes an inaccurate and unstable effect of displaying on the screen, thereby affecting the experience of the speech interaction. For example, as illustrated in FIG. 1, an audio content “jin tian tian qi zen me yang (Pinyin of Chinese characters, which means: what's the weather like today)” is taken as an example. When real-time speech recognition is performed on the audio by utilizing the SMLTA model, the output result of the CTC module has a high error rate, and the attention decoder relies on post-truncation of the CTC module for decoding during streaming on-screen, therefore the output length of the attention decoder is shorter than the output length of the CTC module during the streaming decoding process. For example, as illustrated in FIG. 1, an output result of the attention decoder is two words less than that of the CTC module, and a spliced result may be “jin tian tian zen yang (Pinyin of Chinese characters, which means that what is the sky like today)”, as can be seen that the result displayed on the screen is incorrect.

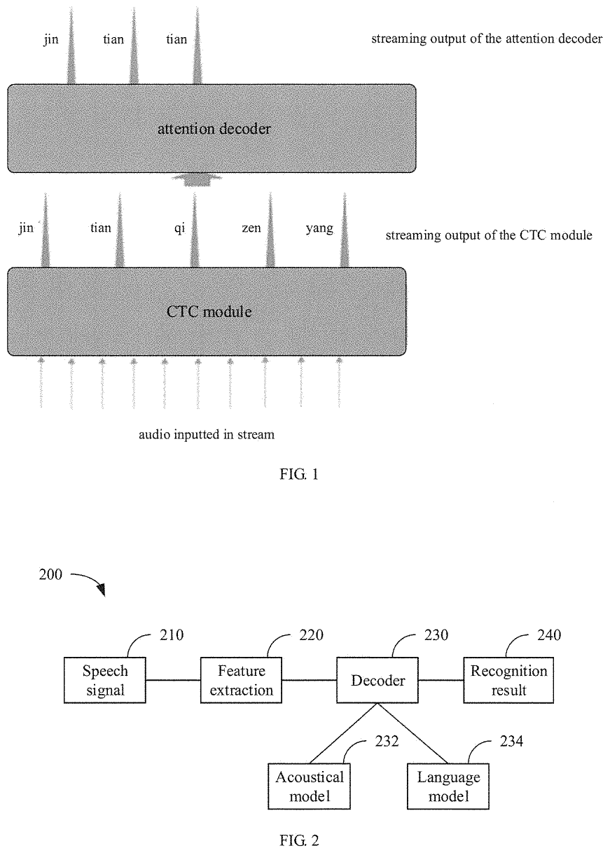

For the above effect of displaying the real-time speech recognition result on the screen, also called on-screen effect there are problems that the speed of displaying the real-time recognition result on the screen is slow or the displayed recognition result is inaccurate. The disclosure provides a method and an apparatus for displaying a streaming speech recognition result, an electronic device, and a storage medium. According to the method for displaying the streaming speech recognition result provided by embodiments of the disclosure, a result of a streaming attention model decoder is refreshed by simulating a sentence ending of a streaming input, thereby ensuring the reliability of the streaming on-screen effect and improving the on-screen display speed of the real-time speech recognition result. Description will be made in detail below to some exemplary implementations of embodiments of the disclosure with reference to FIGS. 2-9.

FIG. 2 is a block diagram illustrating a processing procedure 200 of speech recognition according to embodiments of the disclosure. Generally, a speech recognition system may include devices such as an acoustic model, a language model and a decoder. As illustrated in FIG. 2, after a collected speech signal 210 is obtained, signal processing and feature extraction are performed on the speech signal 210 at block 220, including extracting a feature from the input speech signal 210 for subsequent processing of the acoustic model. In some embodiments, the feature extraction procedure also includes other signal processing techniques to reduce influence of environmental noise or other factors on the feature.

Referring to FIG. 2, after the feature extraction 220 is completed, the extracted feature is input to the decoder 230, and the decoder 230 processes the extracted feature to output a text recognition result 240. In detail, the decoder 230 searches for a text sequence of a speech signal outputted with a maximum probability based on an acoustic model 232 and a language model 234. The acoustic model 232 may implement conversion from a speech to speech segments, while the language model 234 may implement conversion from the speech segments to a text.

The acoustic model 232 is configured to perform joint modeling of acoustics and language on the speech segment. For example, a modeling unit of the joint modeling may be a syllable. In some embodiments of the disclosure, the acoustic model 232 may be the streaming multi-layer truncated attention (SMLTA) model. The SMLTA model may segments the speech into multiple small segments by utilizing the peak information of the CTC model, such that attention model modeling and decoding may be performed on each small segment. Such SMLTA model may support real-time streaming speech recognition and achieve a high recognition accuracy.

The language model 234 is configured to model a language. Generally, statistical N-gram may be used, that is, a probability that each sequence of N words appears is counted. It should be understood that, any known or later developed language model may be used in conjunction with embodiments of the disclosure. In some embodiments, the acoustic model 232 may be trained and/or operated based on a speech database, and the language model 234 may be trained and/or operated based on a text database.

The decoder 230 may implement dynamic decoding based on output recognition results of the acoustic model 232 and the language model 234. In a certain speech recognition scene, when a user speaks to his/her user equipment, and a speech (and sound) generated by the user is collected by the user equipment. For example, the speech may be collected by a sound collection component (such as a microphone) of the user equipment. The user equipment may be any electronic device capable of collecting the speech signal, including but not limited to, a smart phone, a tablet, a desktop computer, a notebook, a smart wearable device (such as a smart watch and a pair of smart glasses), a navigation device, a multimedia player device, an educational device, a game device, a smart speaker, and so on. The user equipment may send the speech to a server in segments via the network during collection. The server includes a speech recognition model. The speech recognition model may implement real-time and accurate speech recognition. After the speech recognition is completed, a recognition result may be sent to the user equipment via the network. It should be understood that, the method for displaying the streaming speech recognition result according to embodiments of the disclosure may be executed at the user equipment or the server, or some parts of the method are executed at the user equipment and other parts are executed at the server.

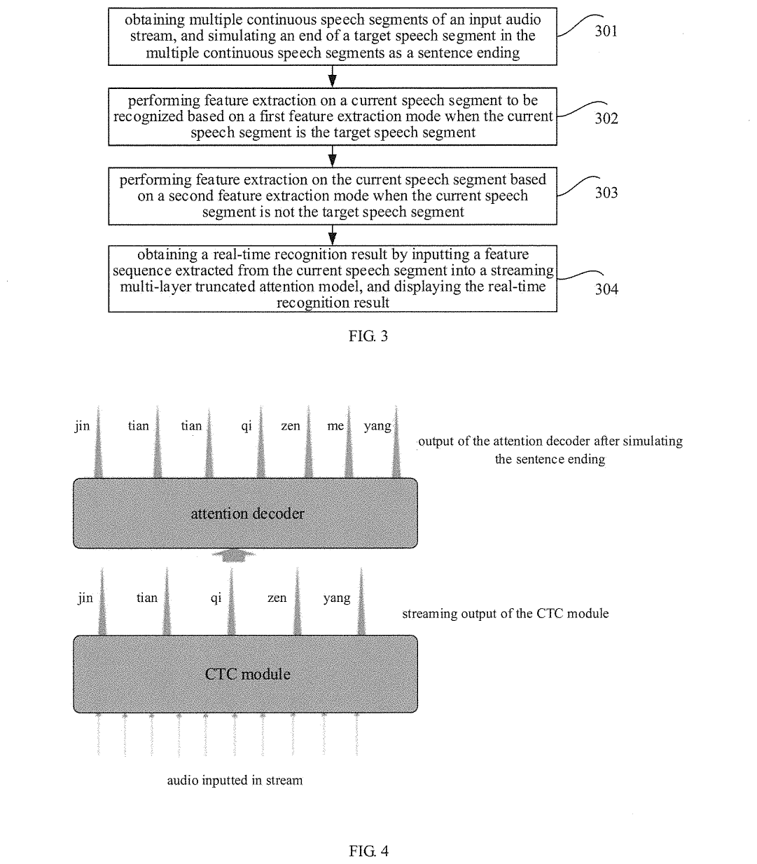

FIG. 3 is a flow chart illustrating a method for displaying a streaming speech recognition result according to an embodiment of the disclosure. It should be understood that the method for displaying the streaming speech recognition result according to embodiments of the disclosure may be executed by an electronic device (such as user equipment), a server, or a combination thereof. As illustrated in FIG. 3, the method for displaying the streaming speech recognition result may include the following.

At block 301, multiple continuous speech segments of an input audio stream are obtained, and an end of a target speech segment in the multiple continuous speech segments is simulated as a sentence ending. The sentence ending is configured to indicate an end of input of the audio stream.

In some embodiments, when the multiple continuous speech segments of the input audio stream are obtained, the target speech segment may be found out from the multiple continuous speech segments first, and then the end of the target speech segment is simulated as the sentence ending. In this way, by simulating the sentence ending at the end of the target speech segment, the streaming multi-layer truncated attention model may be informed that a complete audio is received presently, such that the attention decoder in the streaming multi-layer truncated attention model may immediately output a current complete recognition result.

At block 302, feature extraction is performed on a current speech segment to be recognized based on a first feature extraction mode when the current speech segment is the target speech segment.

It should be noted that, a feature extraction method of a speech segment containing a sentence ending symbol is different from a feature extraction method of a speech segment without the sentence ending symbol. Therefore, when a feature sequence of the current speech segment is extracted, it may be determined whether the current speech segment is the target speech segment first, and a feature extraction method corresponding to the determination result may be adopted based on the determination result.

In some embodiments, it is determined whether the current speech segment is the target speech segment. When the current speech segment is the target speech segment, that is, a symbol for marking the sentence ending is added at an end of the current speech segment, the current speech segment may be input into an encoder for feature extraction. The ending of the current speech segment contains the sentence-ending symbol, therefore, the encoder performs the feature extraction on the current speech segment based on the first feature extraction mode to obtain a feature sequence of the current speech segment.

In other words, the feature sequence may be obtained by encoding the current speech segment using the first feature extraction mode by the encoder. For example, when the current speech segment is the target speech segment, the encoder encodes the current speech segment into a hidden feature sequence based on the first feature extraction mode. The hidden feature sequence is the feature sequence of the current speech segment.

At block 303, feature extraction is performed on the current speech segment based on a second feature extraction mode when the current speech segment is not the target speech segment.

In some embodiments, when it is determined that the current speech segment is not the target speech segment, that is, the ending segment of the current speech segment does not contain the symbol for marking the sentence ending, the current speech segment may be input into the encoder for feature extraction. Since the ending segment of the current speech segment does not contain the sentence-ending symbol, the encoder performs the feature extraction on the current speech segment based on the second feature extraction mode to obtain a feature sequence of the current speech segment.

In other words, the feature sequence may be obtained by encoding the current speech segment using the second feature extraction mode by the encoder. For example, when the current speech segment is not the target speech segment, the encoder encodes the current speech segment into a hidden feature sequence based on the second feature extraction mode. The hidden feature sequence is the feature sequence of the current speech segment.

At block 304, a real-time recognition result is obtained by inputting the feature sequence extracted from the current speech segment into the streaming multi-layer truncated attention model, and the real-time recognition result is displayed.

In some embodiments of the disclosure, the streaming multi-layer truncated attention model may include the connectionist temporal classification (CTC) module and the attention decoder. In embodiments of the disclosure, the feature sequence extracted from the current speech segment may be input into the streaming multi-layer truncated attention model. The CTC processing is performed on the feature sequence of the current speech segment based on the CTC module to obtain the peak information related to the current speech segment, and the real-time recognition result is obtained through the attention decoder based on the current speech segment and the peak information

For example, the peak information related to the current speech segment is obtained by performing the CTC processing on the feature sequence of the current speech segment based on the CTC module. Truncation information of the feature sequence of the current speech segment is determined based on the obtained peak information, and the feature sequence of the current speech segment is truncated into multiple subsequences based on the truncation information. The real-time recognition result is obtained through the attention decoder based on the multiple subsequences.

In some embodiments, the truncation information may be the peak information related to the current speech segment and obtained by performing the CTC processing on the feature sequence. The CTC processing may output a sequence of peaks, and the peaks may be separated by blanks. One peak may represent a syllable or a group of phones, such as a combination of high-frequency phones. It should be understood that, although description is made in the following part of the disclosure by taking the peak information as an example for providing the truncation information, any other currently known or not developed models and/or algorithms that are able to provide the truncation information of the input speech signal may also be used in combination with embodiments of the disclosure.

For example, the feature sequence (such as the hidden feature sequence) of the current speech segment may be truncated into multiple hidden feature subsequences based on the truncation information by using an attention decoder. The hidden feature sequence may be a vector for representing the features of the speech signal. For example, the hidden feature sequence may refer to a feature vector that may not be directly observed but may be determined based on observable variables. In embodiments of the disclosure, different from a truncation mode using a fixed length in the conventional technologies, the truncation information determined based on the speech signal is employed to perform the feature truncation, avoiding exclusion of effective feature parts, thereby achieving a high accuracy.

In embodiments of the disclosure, after the hidden feature subsequences of the current speech segment are obtained, the attention decoder uses the attention model to obtain a recognition result for each hidden feature subsequence obtained by truncation. The attention model is able to implement weighted feature selection and assign corresponding weights to different parts of the hidden feature. Any model and/or algorithm based on the attention mechanism currently known or developed in the future may be employed in combination with embodiments of the disclosure. Therefore, in embodiments of the disclosure, by introducing the truncation information determined based on the speech signal into the conventional attention model, the attention model may be guided to perform attention modeling for each truncation, which may implement not only continuous speech recognition, but also ensure high accuracy.

In some embodiments, after the hidden feature sequence is truncated into the multiple subsequences, a first attention modeling of the attention model may be performed on a first subsequence in the multiple subsequences, and a second attention modeling of the attention model may be performed on a second subsequence in the multiple subsequences. The first attention modeling is different from the second attention modeling. In other words, attention modeling of the attention model for a partial truncation may be implemented in embodiments of the disclosure.

In order to ensure a normal operation of the subsequent streaming calculation, in some embodiments of the disclosure, after the feature sequence extracted from the current speech segment is input into the streaming multi-layer truncated attention model, a model state of the streaming multi-layer truncated attention model is stored. In embodiments of the disclosure, in a case that the current speech segment is the target speech segment, and that a feature sequence of a following speech segment to be recognized is input to the streaming multi-layer truncated attention model, a model state stored when speech recognition is performed on the target speech segment based on the streaming multi-layer truncated attention model is obtained, and a real-time recognition result of the following speech segment is obtained through the streaming multi-layer truncated attention model based on the stored model state and the feature sequence of the following speech segment.

In other words, the current model state of the streaming multi-layer truncated attention model may be stored before the recognition result is streaming displayed on the screen. When the recognition of the current speech segment subjected to simulating the sentence ending is completed through the streaming multi-layer truncated attention model, and the real-time recognition result is displayed on the screen, the stored model state may be restored to a model cache. In this way, when speech recognition is performed on the following speech segment, the real-time recognition result of the following speech segment may be obtained through the streaming multi-layer truncated attention model based on the stored model state and the feature sequence of the following speech segment. Therefore, by storing the model state before the streaming display-on-screen, the stored model state is restored to the model cache when recognition is performed on the following speech segment, to ensure the normal operation of the subsequent streaming calculation.

It should be noted that, the attention decoder outputs a complete recognition result after receiving a whole audio. In order to display all the recognition results of the streaming speech on the screen as soon as possible, that is, to speed up the output of the recognition results of the attention decoder, according to embodiments of the disclosure, the streaming multi-layer truncated attention model is deceived that the whole audio is received currently by simulating the end of the target speech segment in the multiple continuous speech segments as the sentence ending, such that the attention decoder in the streaming multi-layer truncated attention model may immediately output the current complete recognition result. For example, as illustrated in FIG. 4, taking the streaming speech segment “jin tian tian qi zen me yang” as an example, the attention decoder may output a complete recognition result after the ending of the streaming speech segment is simulated as the sentence ending. In this way, the recognition result is often closer to a real recognition result, thereby ensuring the reliability of the effect of displaying the real-time recognition result on the screen, and improving the speed of displaying the real-time speech recognition result on the screen, thus making a downstream module enable to pre-charge TTS resources in time based on an on-screen result, thereby improving a response speed of speech interaction.

According to the technical solution of the disclosure, problems that a real-time speech recognition result in the related art has a slow display speed or is displayed inaccurately on the screen are solved.

The result of the decoder of the streaming attention model is refreshed by simulating the sentence ending of the streaming input, thereby ensuring the reliability of the streaming on-screen effect, and improving the on-screen display speed of the real-time speech recognition result. In this way, a downstream module is able to pre-charge TTS resources in time based on an on-screen result, thereby improving a response speed of speech interaction.

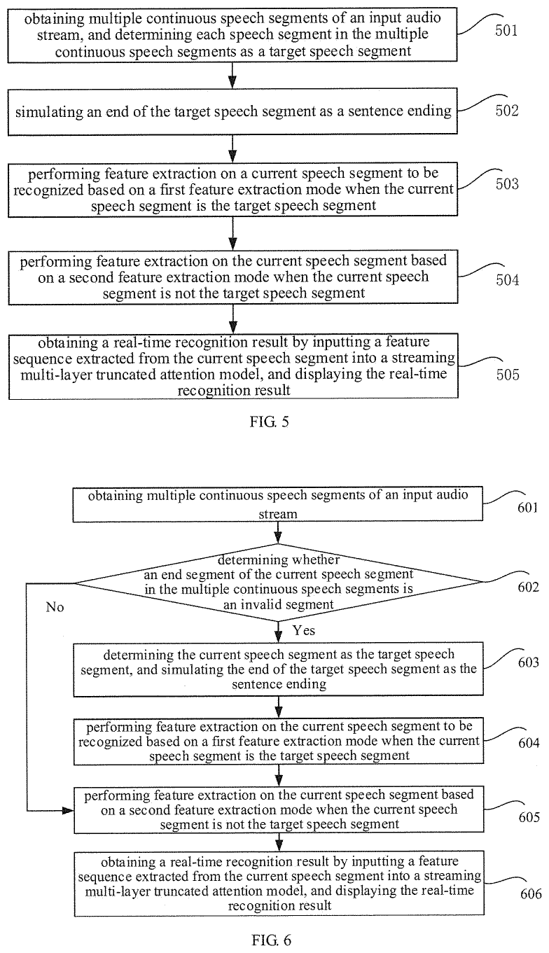

FIG. 5 is a flow chart illustrating a method for displaying a streaming speech recognition result according to another embodiment of the disclosure. As illustrated in FIG. 5, the method for displaying the streaming speech recognition result may include the following.

At block 501, multiple continuous speech segments of an input audio stream are obtained, and each speech segment in the multiple continuous speech segments is determined as a target speech segment.

At block 502, an end of the target speech segment is simulated as a sentence ending. The sentence ending is configured to indicate an end of input of the audio stream.

In other words, when the multiple continuous speech segments of the audio stream are obtained, the ending of each speech segment in the multiple continuous speech segments may be simulated as the sentence ending.

At block 503, feature extraction is performed on a current speech segment to be recognized based on a first feature extraction mode when the current speech segment is the target speech segment.

At block 504, the feature extraction is performed on the current speech segment based on a second feature extraction mode when the current speech segment is not the target speech segment.

At block 505, a feature sequence extracted from the current speech segment is input into the streaming multi-layer truncated attention model, and a real-time recognition result is obtained and displayed.

It should be noted that, the implementation of the actions at blocks 503-505 may refer to the implementation of the actions at blocks 302-304 in FIG. 3, which is not elaborated here.

With the method for displaying the streaming speech recognition result according to embodiments of the disclosure, the streaming multi-layer truncated attention model outputs the complete recognition result of the attention decoder when receiving the whole audio, otherwise the output recognition result of the attention decoder is always shorter than that of the CTC module. In order to improve the on-screen display speed of the streaming speech recognition results, according to embodiments of the disclosure, the ending of each speech segment in the multiple continuous speech segments of the audio stream is simulated as the sentence ending before streaming display-on-screen, to deceive the streaming multi-layer truncated attention model that it receives the whole audio and enables the attention decoder to output the complete recognition result. In this way, the reliability of the streaming display-on-screen effect is ensured, and the speed of displaying the real-time speech recognition result on the screen is improved, such that a downstream module may timely pre-charge TTS resources based on the result displayed on the screen, and the response speed of the speech interaction may be improved.

FIG. 6 is a flow chart illustrating a method for displaying a streaming speech recognition result according to another embodiment of the disclosure. It should be noted that, when recognition is performed on the current speech segment subjected to simulating the sentence ending, the model state needs to be pre-stored, multi-round complete calculation needs to be performed, and then the model state is rolled back. Such calculation may consume a large amount of calculation. Therefore, in order to ensure outputting a final recognition result in advance (that is, to improve the speed of streaming speech recognition result), and also in order to ensure that the increase of the amount of calculation is within a controllable range, in embodiments of the disclosure, when an end segment of the current speech segment in the multiple continuous speech segments contains mute data, the end of the current speech segment is simulated as the sentence ending. In detail, as illustrated in FIG. 6, the method for displaying the streaming speech recognition result may include the following.

At block 601, multiple continuous speech segments of an input audio stream is obtained.

At block 602, it is determined whether an end segment of the current speech segment in the multiple continuous speech segments is an invalid segment. The invalid segment contains mute data.

For example, speech activity detection may be performed on the current speech segment in the multiple continuous speech segments, and such detection may also be called speech boundary detection. The detection may be used to detect a speech activity signal in a speech segment, so that valid data containing the continuous speech signals and mute data containing no speech signal data are determined in speech segment data. A mute segment containing no continuous speech signal data is an invalid sub-segment in the speech segment. At this block, the speech boundary detection may be performed based on the end segment of the current speech segment in the multiple continuous speech segments to determine whether the end segment of the current speech segment is the invalid segment.

In embodiments of the disclosure, when the end segment of the current speech segment is the invalid segment, the action at block 603 is executed. When the end segment of the current speech segment is not the invalid segment, it may be determined that the current speech segment is not the target speech segment, and the action at block 605 may be executed.

At block 603, the current speech segment is determined as the target speech segment, and the end of the target speech segment is simulated as the sentence ending. The sentence ending is configured to indicate the end of input of the audio stream.

At block 604, when the current speech segment is the target speech segment, the feature extraction is performed on the current speech segment based on a first feature extraction mode.

At block 605, when the current speech segment is not the target speech segment, the feature extraction is performed on the current speech segment based on a second feature extraction mode.

At block 606, a feature sequence extracted from the current speech segment is input into the streaming multi-layer truncated attention model, and a real-time recognition result is obtained and displayed.

It should be noted that, the implementation of the actions at blocks 604-606 may refer to the implementation of the actions at blocks 302-304 in FIG. 3, which is not elaborated here.

With the method for displaying the streaming speech recognition result according to embodiments of the disclosure, it is determined whether the end segment of the current speech segment in the multiple continuous speech segments is the invalid segment, the invalid segment containing the mute data. If so, the current speech segment is determined as the target speech segment, and the end of the target speech segment is simulated as the sentence ending, thus the streaming multi-layer truncated attention model is deceived that a whole audio is received presently, such that the attention decoder in the streaming multi-layer truncated attention model immediately outputs the current complete recognition result. In this way, by adding the operation of determining whether the end segment of the current speech segment in the multiple continuous speech segments contains the mute data, the speech segment whose end segment contains the mute data is taken as the target speech segment, that is, the sentence ending is simulated at the end segment containing the mute data. In this way, the final recognition result may be output in advance, that is, the speed of the streaming speech recognition result may be improved, and it is ensured that the increase of the amount of calculation may be within a controllable range.

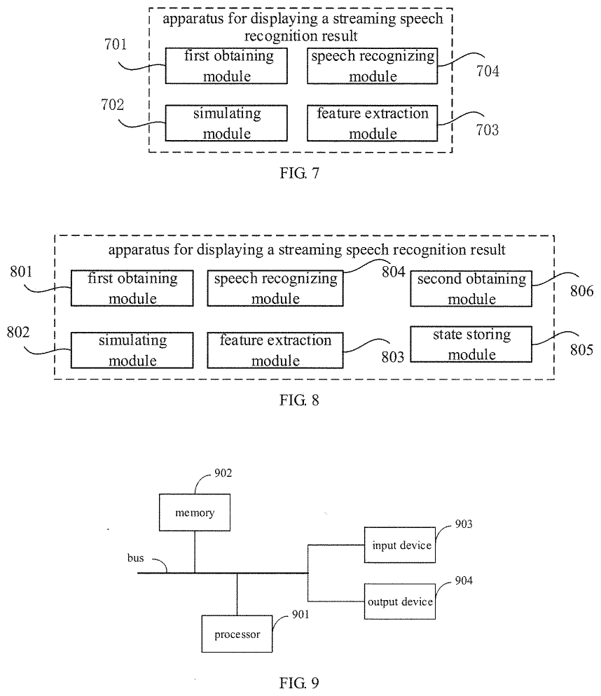

FIG. 7 is a block diagram illustrating an apparatus for displaying a streaming speech recognition result according to an embodiment of the disclosure. As illustrated in FIG. 7, the apparatus for displaying the streaming speech recognition result may include: a first obtaining module 701, a simulating module 702, a feature extraction module 703, and a speech recognizing module 704.

In detail, the first obtaining module 701 is configured to obtain multiple continuous speech segments of an input audio stream.

The simulating module 702 is configured to simulate an end of a target speech segment in the multiple continuous speech segments as a sentence ending. The sentence ending is configured to indicate an end of input of the audio stream. In some embodiments of the disclosure, the simulating module 702 is configured to: determine each speech segment in the multiple continuous speech segments as the target speech segment; and simulate the end of the target speech segment as the sentence ending.

In order to ensure that the final recognition result is output in advance, and also that an increase of the amount of calculation is within a controllable range, in some embodiments of the disclosure, the simulating module 702 is configured to: determine whether an end segment of the current speech segment in the multiple continuous speech segments is an invalid segment, the invalid segment containing mute data; determine that the current speech segment is the target speech segment in a case that the end segment of the current speech segment is the invalid segment; and simulate the end of the target speech segment as the sentence ending.

The feature extraction module 703 is configured to perform feature extraction on a current speech segment to be recognized based on a first feature extraction mode when the current speech segment is the target speech segment, and to perform feature extraction on the current speech segment based on a second feature extraction mode when the current speech segment is not the target speech segment.

The speech recognizing module 704 is configured to obtain a real-time recognition result by inputting a feature sequence extracted from the current speech segment into a streaming multi-layer truncated attention model, and to display the real-time recognition result. In some embodiments of the disclosure, the speech recognizing module 704 is configured to: obtain peak information related to the current speech segment through performing connectionist temporal classification processing on the feature sequence based on the connectionist temporal classification module; and obtain the real-time recognition result through the attention decoder based on the current speech segment and the peak information.

In some embodiments of the disclosure, as illustrated in FIG. 8, the apparatus for displaying the streaming speech recognition result may also include: a state storing module 805, and a second obtaining module 806. The state storing module 805 is configured to store a model state of the streaming multi-layer truncated attention model. The second obtaining module 806 is configured to, in a case that the current speech segment is the target speech segment and that a feature sequence of a following speech segment to be recognized is input to the streaming multi-layer truncated attention model, obtain a model state stored when speech recognition is performed on the target speech segment based on the streaming multi-layer truncated attention model. The speech recognizing module 804 is also configured to obtain a real-time recognition result of the following speech segment through the streaming multi-layer truncated attention model based on the stored model state and the feature sequence of the following speech segment. In this way, the normal operation of the subsequent streaming calculation may be ensured.

Blocks 801-804 in FIG. 8 have the same function and structure as blocks 701-704 in FIG. 7.

With regard to the apparatus in the above embodiments, a way in which each module performs operations is described in detail in the embodiments related to the method, which will not be elaborated here.

According to the apparatus for displaying the streaming speech recognition result of embodiments of the disclosure, by simulating the end of the target speech segment in the multiple continuous speech segments as the sentence ending, the streaming multi-layer truncated attention model is deceived that the whole audio is received currently, such that the attention decoder in the streaming multi-layer truncated attention model may immediately output the current complete recognition result. For example, as illustrated in FIG. 4, taking the streaming speech segment “jin tian tian qi zen me yang” as an example, the attention decoder may output a complete recognition result after the ending of the streaming speech segment is simulated as the sentence ending. In this way, the recognition result is often closer to a real recognition result, thereby ensuring the reliability of the effect of displaying the real-time recognition result on the screen, and improving the speed of displaying the real-time speech recognition result on the screen, thus making a downstream module enable to pre-charge TTS resources in time based on an on-screen result, thereby improving a response speed of speech interaction.

According to embodiments of the disclosure, the disclosure also provides an electronic device and a readable storage medium.

As illustrated in FIG. 9, FIG. 9 is a block diagram illustrating an electronic device for implementing a method for displaying a streaming speech recognition result according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device.

The components, connections and relationships of the components, and functions of the components illustrated herein are merely examples, and are not intended to limit the implementation of the disclosure described and/or claimed herein.

As illustrated in FIG. 9, the electronic device includes: one or more processors 901, a memory 902, and interfaces for connecting various components, including a high-speed interface and a low-speed interface. Various components are connected to each other via different buses, and may be mounted on a common main board or in other ways as required. The processor may process instructions executed within the electronic device, including instructions stored in or on the memory to display graphical information of the GUI (graphical user interface) on an external input/output device (such as a display device coupled to an interface). In other implementations, multiple processors and/or multiple buses may be used together with multiple memories if desired. Similarly, multiple electronic devices may be connected, and each device provides some necessary operations (for example, as a server array, a group of blade servers, or a multiprocessor system). In FIG. 9, a processor 901 is taken as an example.

The memory 902 is a non-transitory computer readable storage medium provided by the disclosure. The memory is configured to store instructions executable by at least one processor, to enable the at least one processor to execute the method for displaying the streaming speech recognition result provided by the disclosure. The non-transitory computer readable storage medium provided by the disclosure is configured to store computer instructions. The computer instructions are configured to enable a computer to execute the method for displaying the streaming speech recognition result provided by the disclosure.

As the non-transitory computer readable storage medium, the memory 902 may be configured to store non-transitory software programs, non-transitory computer executable programs and modules, such as program instructions/module (such as the first obtaining module 701, the simulating module 702, the feature extraction module 703, and the speech recognizing module 704 illustrated in FIG. 7) corresponding to the method for displaying the streaming speech recognition result according to embodiments of the disclosure. The processor 901 is configured to execute various functional applications and data processing of the server by operating non-transitory software programs, instructions and modules stored in the memory 902, that is, implements the method for displaying the streaming speech recognition result according to the above method embodiments.

The memory 902 may include a storage program region and a storage data region. The storage program region may store an application required by an operating system and at least one function. The storage data region may store data created according to predicted usage of the electronic device capable of implementing the method for displaying the streaming speech recognition result. In addition, the memory 902 may include a high-speed random access memory, and may also include a non-transitory memory, such as at least one disk memory device, a flash memory device, or other non-transitory solid-state memory device. In some embodiments, the memory 902 may optionally include memories remotely located to the processor 901, and these remote memories may be connected to the electronic device capable of implementing the method for displaying the streaming speech recognition result via a network. Examples of the above network include, but are not limited to, an Internet, an intranet, a local area network, a mobile communication network and combinations thereof.

The electronic device capable of implementing the method for displaying the streaming speech recognition result may also include: an input device 903 and an output device 904. The processor 901, the memory 902, the input device 903, and the output device 904 may be connected via a bus or in other means. In FIG. 9, the bus is taken as an example.

The input device 903 may receive input digital or character information, and generate key signal input related to user setting and function control of the electronic device capable of implementing the method for displaying the streaming speech recognition result, such as a touch screen, a keypad, a mouse, a track pad, a touch pad, an indicator stick, one or more mouse buttons, a trackball, a joystick and other input device. The output device 904 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general purpose programmable processor, may receive data and instructions from a storage system, at least one input device, and at least one output device, and may transmit data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including a machine readable medium that receives machine instructions as a machine readable signal. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, moderationory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, also known as a cloud computing server or a cloud host, which is a host product in a cloud computing service system, to solve difficult management and weak business scalability in conventional physical host and VPS (virtual private server) services.

It should be understood that, steps may be reordered, added or deleted by utilizing flows in the various forms illustrated above. For example, the steps described in the disclosure may be executed in parallel, sequentially or in different orders, so long as desired results of the technical solution disclosed in the disclosure may be achieved, there is no limitation here.

The above detailed implementations do not limit the protection scope of the disclosure. It should be understood by the skilled in the art that various modifications, combinations, sub-combinations and substitutions may be made based on design requirements and other factors. Any modification, equivalent substitution and improvement made within the principle of the disclosure shall be included in the protection scope of disclosure.

What is claimed is:

1. A method for displaying a streaming speech recognition result, comprising:
obtaining a plurality of continuous speech segments of an input audio stream, and simulating an end of a target speech segment in the plurality of continuous speech segments as a sentence ending, the sentence ending being configured to indicate an end of input of the audio stream;
performing feature extraction on a current speech segment to be recognized based on a first feature extraction mode when the current speech segment is the target speech segment:
performing feature extraction on the current speech segment based on a second feature extraction mode when the current speech segment is not the target speech segment; and
obtaining a real-time recognition result by inputting a feature sequence extracted from the current speech segment into a streaming multi-layer truncated attention model, and displaying the real-time recognition result.

2. The method of claim 1, wherein simulating the end of the target speech segment in the plurality of continuous speech segments as the sentence ending comprises:
determining each speech segment in the plurality of continuous speech segments as the target speech segment; and
simulating the end of the target speech segment as the sentence ending.

3. The method of claim 1, wherein simulating the end of the target speech segment in the plurality of continuous speech segments as the sentence ending comprises:
determining whether an end segment of the current speech segment in the plurality of continuous speech segments is an invalid segment, the invalid segment containing mute data;
determining that the current speech segment is the target speech segment in a case that the end segment of the current speech segment is the invalid segment; and
simulating the end of the target speech segment as the sentence ending.

4. The method of claim 1, wherein the streaming multi-layer truncated attention model comprises a connectionist temporal classification module and an attention decoder, and obtaining the real-time recognition result by inputting the feature sequence extracted from the current speech segment into the streaming multi-layer truncated attention model comprises:
obtaining peak information related to the current speech segment by performing connectionist temporal classification processing on the feature sequence based on the connectionist temporal classification module; and
obtaining the real-time recognition result through the attention decoder based on the current speech segment and the peak information.

5. The method of claim 1, after inputting the feature sequence extracted from the current speech segment into the streaming multi-layer truncated attention model, further comprising:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

6. The method of claim 2, after inputting the feature sequence extracted from the current speech segment into the streaming multi-layer truncated attention model, further comprising:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

7. The method of claim 3, after inputting the feature sequence extracted from the current speech segment into the streaming multi-layer truncated attention model, further comprising:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

8. The method of claim 4, after inputting the feature sequence extracted from the current speech segment into the streaming multi-layer truncated attention model, further comprising:
storing a model state of the streaming multi-layer truncated attention model:
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

9. An electronic device, comprising:
at least one processor; and
a memory communicatively coupled to the at least one processor,
wherein the memory is configured to store instructions executable by the at least one processor, and when the instructions are executed by the at least one processor, the at least one processor is caused to execute a method for displaying a streaming speech recognition result, the method comprising:
obtaining a plurality of continuous speech segments of an input audio stream, and simulating an end of a target speech segment in the plurality of continuous speech segments as a sentence ending, the sentence ending being configured to indicate an end of input of the audio stream;
performing feature extraction on a current speech segment to be recognized based on a first feature extraction mode when the current speech segment is the target speech segment;
performing feature extraction on the current speech segment based on a second feature extraction mode when the current speech segment is not the target speech segment; and
obtaining a real-time recognition result by inputting a feature sequence extracted from the current speech segment into a streaming multi-layer truncated attention model, and displaying the real-time recognition result.

10. The electronic device of claim 9, wherein simulating the end of the target speech segment in the plurality of continuous speech segments as the sentence ending comprises:
determining each speech segment in the plurality of continuous speech segments as the target speech segment; and
simulating the end of the target speech segment as the sentence ending.

11. The electronic device of claim 9, wherein simulating the end of the target speech segment in the plurality of continuous speech segments as the sentence ending comprises:
determining whether an end segment of the current speech segment in the plurality of continuous speech segments is an invalid segment, the invalid segment containing mute data;
determining that the current speech segment is the target speech segment in a case that the end segment of the current speech segment is the invalid segment; and
simulating the end of the target speech segment as the sentence ending.

12. The electronic device of claim 9, wherein the streaming multi-layer truncated attention model comprises a connectionist temporal classification module and an attention decoder, and obtaining the real-time recognition result by inputting the feature sequence extracted from the current speech segment into the streaming multi-layer truncated attention model comprises:
obtaining peak information related to the current speech segment by performing connectionist temporal classification processing on the feature sequence based on the connectionist temporal classification module; and
obtaining the real-time recognition result through the attention decoder based on the current speech segment and the peak information.

13. The electronic device of claim 9, wherein, after inputting the feature sequence extracted from the current speech segment into the streaming multi-layer truncated attention model, the method further comprises:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

14. The electronic device of claim 10, wherein, after inputting the feature sequence extracted from the current speech segment into the streaming multi-layer truncated attention model, the method further comprises:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

15. The electronic device of claim 11, wherein, after inputting the feature sequence extracted from the current speech segment into the streaming multi-layer truncated attention model, the method further comprises:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.

16. A non-transitory computer readable storage medium having computer instructions stored thereon, wherein the computer instructions are configured to cause a computer to execute a method for displaying a streaming speech recognition result, the method comprising:
obtaining a plurality of continuous speech segments of an input audio stream, and simulating an end of a target speech segment in the plurality of continuous speech segments as a sentence ending, the sentence ending being configured to indicate an end of input of the audio stream;
performing feature extraction on a current speech segment to be recognized based on a first feature extraction mode when the current speech segment is the target speech segment;
performing feature extraction on the current speech segment based on a second feature extraction mode when the current speech segment is not the target speech segment; and
obtaining a real-time recognition result by inputting a feature sequence extracted from the current speech segment into a streaming multi-layer truncated attention model, and displaying the real-time recognition result.

17. The non-transitory computer readable storage medium of claim 16, wherein simulating the end of the target speech segment in the plurality of continuous speech segments as the sentence ending comprises:
determining each speech segment in the plurality of continuous speech segments as the target speech segment; and
simulating the end of the target speech segment as the sentence ending.

18. The non-transitory computer readable storage medium of claim 16, wherein simulating the end of the target speech segment in the plurality of continuous speech segments as the sentence ending comprises:
determining whether an end segment of the current speech segment in the plurality of continuous speech segments is an invalid segment, the invalid segment containing mute data;
determining that the current speech segment is the target speech segment in a case that the end segment of the current speech segment is the invalid segment; and
simulating the end of the target speech segment as the sentence ending.

19. The non-transitory computer readable storage medium of claim 16, wherein the streaming multi-layer truncated attention model comprises a connectionist temporal classification module and an attention decoder, and obtaining the real-time recognition result by inputting the feature sequence extracted from the current speech segment into the streaming multi-layer truncated attention model comprises:
obtaining peak information related to the current speech segment by performing connectionist temporal classification processing on the feature sequence based on the connectionist temporal classification module; and
obtaining the real-time recognition result through the attention decoder based on the current speech segment and the peak information.

20. The non-transitory computer readable storage medium of claim 16, wherein, after inputting the feature sequence extracted from the current speech segment into the streaming multi-layer truncated attention model, the method further comprises:
storing a model state of the streaming multi-layer truncated attention model;
wherein in a case that the current speech segment is the target speech segment and that a feature sequence of a following speech segment to be recognized is input to the streaming multi-layer truncated attention model, the method further comprises:
obtaining a model state stored when speech recognition is performed on the target speech segment based on the streaming multi-layer truncated attention model; and
obtaining a real-time recognition result of the following speech segment through the streaming multi-layer truncated attention model based on the stored model state and the feature sequence of the following speech segment.
